(19) United States
(12) Patent Application Publication
(10) Pub. No.: US 2026/0355918 A1
(43) Pub. Date: Nov. 12, 2026

(54) Drive Unit for a Pressing Device

(71) Applicant: Novopress GmbH Pressen und Presswerkzeuge & Co., KG, Neuss (DE)

(72) Inventor: Martin Bungter, Mönchengladbach (DE)

(21) Appl. No.: 19/142,267

(22) PCT Filed: Nov. 28, 2023
(86) PCT No.: PCT/EP2023/083404

§ 371 Date: Jun. 23, 2025

(30) Foreign Application Priority Data
Dec. 29, 2022 (DE) 10 2022 134 975.6

(51) Int. Cl. B25B 27/10

(52) U.S. Cl. CPC B25B 27/10

(57) ABSTRACT

A drive unit for a pressing device including a housing, a drive arranged in the housing, a piston which can be moved by the drive from a stop position into a pressing position in order to transmit the force from the drive to a pressing tool which can be connected to the drive unit, and a connecting element. The connecting element is connected to the housing and has a receptacle for connection to a pressing tool, wherein the connecting element is lockable in at least a first position and a second position, wherein a distance between the stop position of the piston and the receptacle is different in the first position and in the second position.

### CROSS-REFERENCE TO RELATED APPLICATIONS

This application is the United States national phase of International Patent Application No. PCT/EP2023/083404 filed Nov. 28, 2023, and claims priority to German Patent Application No. 10 2022 134 975.6 filed Dec. 29, 2022, the disclosures of which are hereby incorporated by reference in their entireties.

### BACKGROUND OF THE INVENTION

### Field of the Invention

The present invention relates to a drive unit for a pressing device and a pressing device.

### Description of Related Art

Known pressing devices for pressing press fittings or the like have a drive unit with an electric or electro-hydraulic drive. A pressing tool is connected to the drive unit, wherein the pressing tool has pressing jaws that are pivotable about respective pivot axes. The drive moves a movable piston to transmit the force from the drive to the pressing jaws of the pressing tool. Here, the movement of the piston pushes the first ends of the pressing jaws of the pressing tool apart, so that the pressing jaws are pivoted about the pivot axis and the second ends of the pressing jaws are moved towards each other to generate the pressing force.

When using different pressing tools, it may be necessary to adjust the piston stroke used to generate a different pressing stroke or pressing energy for the respective pressing tools.

EP 1979110 proposes to adjust the stop position of the piston when the piston returns in order to achieve different end positions of the piston when the piston returns. This changes the starting position of the piston during the next pressing, so that a different travel distance of the piston can be achieved by changing the end position or the piston stop, respectively. However, EP 1979110 has the disadvantage that if the piston stop is modified, the return spring of the piston is in an increased preloaded state even when not in use. In EP 1979110, it is only possible to change the travel distance when carrying out a pressing operation. The piston must be moved beyond the position of the new piston stop. Adjusting the pressing path is therefore cumbersome and time-consuming. At the same time, the length of the drive unit is based on the maximum travel distance, as only the end position of the piston stop is adjusted. This results in an excessively long drive unit, which is unwieldy and therefore cumbersome for the user to operate.

### SUMMARY OF THE INVENTION

The object of the present invention is to provide a drive unit for a pressing device in which the piston stroke or pressing path for actuating the pressing tool can be adjusted in a simple manner.

The object is achieved with a drive unit and a pressing device as described herein. The drive unit for a pressing device according to the invention comprises a housing and a drive arranged in the housing. The drive can be an electric drive or an electro-hydraulic drive. Furthermore, a piston is provided which can be moved by the drive from a stop position to a pressing position in order to transmit the force from the drive to a pressing tool which can be connected to the drive unit. The piston can have sliding elements or rolling elements that come into contact with the contact surfaces of the pressing tool and are moved along the contact surfaces of the pressing tool to transmit the force. Furthermore, the piston can be connected to a return spring so that after pressing and, for example, after switching off the drive, the piston moves back from the pressing position to a stop position or end position due to the return spring. A new pressing can then be carried out, in which the piston is moved again from the same stop position to the pressing position.

According to the invention, the drive unit comprises a connecting element connected to the housing. The connecting element has a receptacle for receiving or connecting with a pressing tool. Thus, when connected to the drive unit, the pressing tool is connected to the connecting element and then to the housing of the drive unit by the receptacle of the connecting element. In particular, the relative position between the pressing tool and the connecting element is fixed by the receptacle and unchangeable. The connecting element is lockable in at least a first position and a second position, wherein a distance between the stop position of the piston and the receptacle is different in the first position and in the second position. This means that the relative distance between the receptacle of the connecting element and the drive unit or the stop position of the piston differs in the first position and the second position. This makes it easy to change the effective travel distance of the piston. If, for example, the relative distance between the receptacle and the stop position of the piston is smaller in the first position than in the second position, a shorter travel distance of the piston can be achieved in the first position, wherein a shorter pressing path or a smaller pressing energy can be achieved than in the second position. In contrast, in the second position, a pressing tool can be used for which higher pressing energies are required. By changing the position of the connecting element in the first position and in the second position without changing the stop position of the piston, the return spring is always equally preloaded. The position of the connecting element is always changed in a force-free state when the piston is in the stop position, for example when the drive is switched off. At the same time, however, the connecting element can be moved to the second position for transportation or handling of the drive unit, which reduces the overall length of the drive unit.

Preferably, the distance between the first position and the second position is at least 20 mm, preferably at least 40 mm, particularly preferably at least 60 mm. In the first position, for example, the receptacle can be at least 20 mm, preferably at least 40 mm and particularly preferably at least 60 mm further away from the stop position of the piston than in the second position.

Preferably, the maximum travel distance, i.e. the distance between the stop position of the piston and the pressing position of the piston, is 60 mm or more, in particular 80 mm or more, and preferably 100 mm or more.

Preferably, the connecting element is connected to the housing in a telescoping manner. In this case, the connecting element is insertable into the housing or is substantially or at least partially surrounded by the housing. Alternatively, the connecting element at least partially surrounds the housing. In particular, the connecting element has a sleeve that surrounds the housing. The sleeve can be arranged at the end of the connecting element on the housing side.

Preferably, the connecting element comprises a first locking device and/or a second locking device for locking the connecting element in the first position or the second position. Here, the first locking device can also be used to lock the connecting element in the first position and the second position, so that a common locking device is provided for the first position and the second position. Preferably, the first locking device and/or the second locking device can be a fixed stop between the connecting element and the housing of the drive unit.

Preferably, the first locking device and the second locking device are of the same or different design.

Preferably, the first locking device and/or the second locking device is in particular a spring-loaded latching element. In particular, the latching element is formed as a locking pin, latching ball or in the form of a bayonet catch. For example, the latching element can be provided on the connecting element and inserted into corresponding recesses in the housing of the drive unit to lock the connecting element in the first position and/or second position. In particular, the latching element is positively engaged by the recesses. Of course, the latching element can also be connected to the housing and inserted into corresponding recesses of the connecting element.

Preferably, the latching element is one or more latching balls, with the connecting element having a corresponding number of openings to receive the latching balls. In particular, the openings are arranged in the sleeve of the connecting element. In particular, the sleeve has a wall thickness that is smaller than the diameter of the one or more latching balls so that, if the latching balls are arranged in the openings of the connecting element or the sleeve, the respective latching ball protrudes beyond the sleeve of the connecting element. Furthermore, the housing has recesses, wherein the one or more latching balls are arranged simultaneously in the respective opening and the recess for locking in the first position or in the second position. This results in a locking so that the connecting element cannot be displaced relative to the housing.

Preferably, the recess on the housing at the position of the first position and/or at the position of the second position is formed as an at least partially and in particular completely circumferential annular groove, into which the latching balls project over the sleeve of the connecting element during locking. Thus, in particular, the connecting element is rotatable relative to the housing and can be locked in any position in the first position and/or the second position.

Preferably, an operating element is provided which covers the opening of the connecting element, wherein the operating element is displaceable and comprises one or more depressions, wherein, when the connecting element is released, the operating element is displaced such that one of the depressions corresponds at least partially with one of the openings and the latching balls are arranged simultaneously in the opening and the depression and are no longer in engagement with the recess of the housing. This allows the latching ball to be displaced out of the recess of the housing into the depression of the operating element, thus enabling the housing to be moved relative to the connecting element. In particular, in a locking position, the depression is not in line with an opening. In particular, the operating element then forms an abutment surface which lies flat against the surface of the sleeve of the connecting element and thereby holds or locks the latching ball in the opening of the connecting element so that the latching ball simultaneously engages in the recess of the housing. In this way, locking is achieved with regard to a relative displacement of the connecting element to the housing and a relative displaceability is ensured, provided that the depressions of the operating element correspond at least partially with the openings for receiving the latching balls.

Preferably, the first locking device and/or the second locking device is a frictional connection. In particular, the frictional connection can be created by a clamping cone. Thus, for example, the frictional connection can generate a clamping force when a force is applied by moving the piston in the axial direction, in particular by pushing the clamping cone apart, so that the connecting element is locked in the corresponding position. Once the piston has reached the pressing position and returned to the stop position, the frictional connection can be released and the connecting element can be adjusted from its first position to the second position or vice versa.

Preferably, more than two positions and, in particular, continuous adjustment of the connecting element are possible. This makes it easy to realize different travel distances of the piston and, in particular, to continuously adapt the travel distance of the piston to the respective pressing tool.

Preferably, the connecting element has a thread, wherein the position of the connecting element can be changed by the thread. This means that the connecting element can be screwed into the housing of the drive unit or vice versa to change the distance between the receptacle of the connecting element and the stop position of the piston. In particular, such a thread enables continuous adjustment of the connecting element. In particular, the thread can have catches which correspond to the first position and the second position, so that it can engage in the catches, which are in particular in the form of a depression, and the connecting element is thereby locked in the first position or the second position (or in other positions).

Preferably, the stop position of the piston cannot be changed. In contrast to the prior art of EP 1979110, the stop position of the piston cannot be changed in the present invention. Whereas in EP 1979110 the starting position for the movement of the piston is changed in order to adjust the relative distance between the piston and the receptacle, in the present invention the position of the connecting element is changed in order to change this distance.

Furthermore, the present invention relates to a pressing device comprising a drive unit as described above. Furthermore, the pressing device comprises a pressing tool, wherein the pressing tool is connected to the receptacle of the connecting element. In particular, the pressing tool is detachably connected to the connecting element. Alternatively, it is also possible that the pressing tool is fixedly connected to the connecting element and can be replaced together with the connecting element. In this case, the connecting element would be detachably connected to the housing of the drive unit and could be replaced.

### BRIEF DESCRIPTION OF THE DRAWINGS

The terms FIG., FIGS., Figure, and Figures are used interchangeably in the specification to refer to the corresponding figures in the drawings.

In the following, the invention is described in more detail by means of preferred embodiments with reference to the accompanying drawings.

The Figures show:

FIG. 1 shows a drive unit according to the present invention in a sectional view in a first position,

FIG. 2 shows the drive unit according to FIG. 1 in a second sectional view,

FIG. 3 shows the drive unit according to FIG. 1 in a sectional view in a second position,

FIG. 4 shows a further embodiment of the drive unit according to the present invention in a first configuration,

FIG. 5 shows the drive unit according to FIG. 4 in a further configuration,

FIG. 6 shows the drive unit according to FIG. 4 in a further configuration,

FIG. 7 shows a detailed view of the drive unit of FIG. 4,

FIG. 8 shows a further embodiment of the drive unit according to the present invention in a first configuration,

FIG. 9 shows the drive unit according to FIG. 8 in a further configuration,

FIG. 10 shows the drive unit according to FIG. 8 in a further configuration,

FIG. 11 shows the drive unit according to FIG. 8 in a further configuration, and

FIG. 12 shows a detailed view of the drive unit of FIG. 8.

### DESCRIPTION OF THE INVENTION

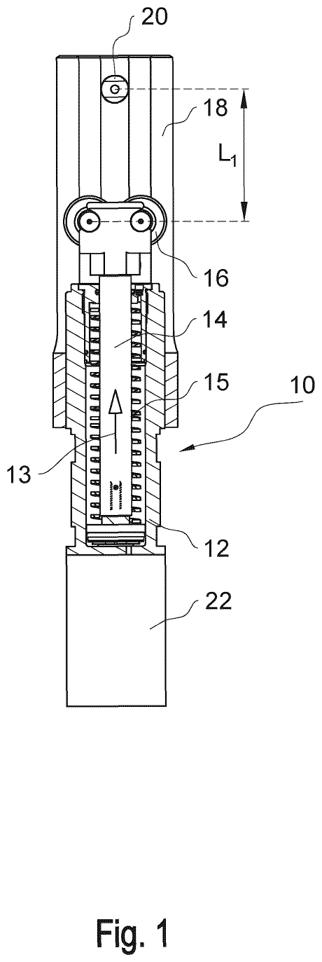

The drive unit 10 according to the invention comprises a housing 12. A drive 22 is arranged in the housing 12 or is connected to the housing 12. The drive 22 can be an electric or an electrohydraulic drive. By means of the drive 22, a piston 14 is moved according to the arrow 13 from a stop position shown in FIGS. 1, 2 and 3 to a pressing position. The piston 14 has rollers 16 at one end, which come into contact with the contact surfaces of a pressing tool (not shown) and thus push the pressing jaws of the pressing tool apart. The pressing jaws are each pivotable via a pivot point or a pivot leg axis, so that the end of the pressing jaws opposite the contact surfaces is pressed together and the force of the drive 22 is thereby transmitted via the piston 14 to the pressing jaws for pressing a press fitting or a workpiece. After performing the pressing operation, the drive 22 is switched off and the piston 14 is moved back from the pressing position to the stop position by means of a return spring 15.

A connecting element 18 is connected to the housing 12. As shown in the figures, the connecting element 18 partially surrounds the housing 12 and is telescopically connected to the housing 12 in the example of the figures. Of course, this can also be implemented the other way round, so that the housing 12 at least partially surrounds the connecting element 18. The connecting element 18 comprises a receptacle 20, which is designed as a bolt in the examples in the figures. A pressing tool is detachably connected to the drive unit 10 by means of the bolt. Thus, different pressing tools can be connected to the drive unit 10.

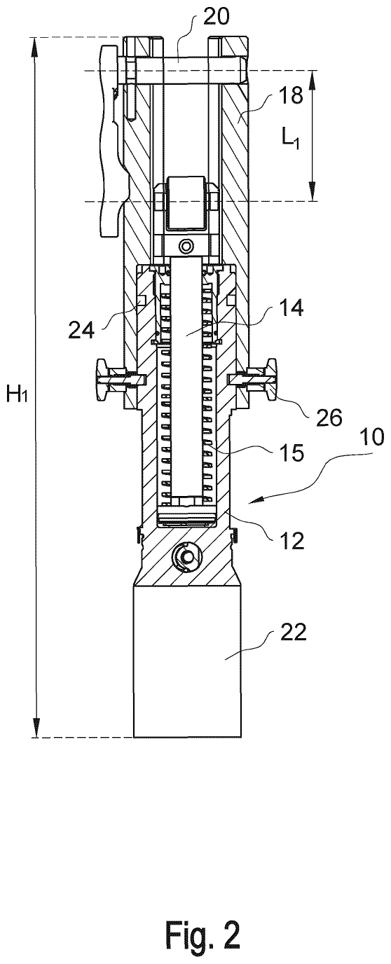

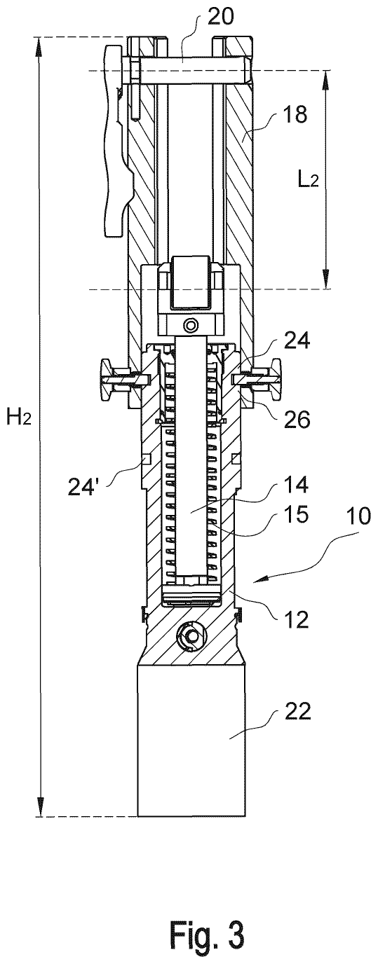

According to the invention, the connecting element 18 can be locked in a first position, shown in FIGS. 1 and 2, and a second position, shown in FIG. 3. In the first position, the distance between the piston in the stop position and the receptable 20 is designated with L₁. In the second position, the distance between the stop position of the piston 14 and the receptable 20 is designated with L₂. Here, L₁ is smaller than L₂. Here, L₁ and L₂ denote the maximum travel distance/pressings paths for the first position of the connecting element and for the second position of the connecting element. For example, L₁ can be 20 mm to 80 mm and preferably 40 mm to 60 mm, wherein L₂ can be 40 mm to 120 mm and preferably 60 mm to 100 mm, for example. Thus, the relative distance of the receptacle 20 from the stop position of the piston 14 can be adjusted. This changes the maximum possible travel distance of the piston 14, whereby the force transmitted to the pressing jaws and/or the pressing path covered by the pressing jaws during pressing are adjusted. The drive unit 10 can therefore be connected to different pressing tools, wherein the respective pressing parameters can be adjusted. As shown in FIGS. 1, 2 and 3, the end position of the piston 14 is always the same. In contrast to the prior art, the stop position of the piston is thus not changed in the present invention. Rather, the distance between the receptacle 20 and the stop position of the piston 14 is achieved by changing the position of the connecting element 18.

According to the invention, the housing 12 comprises first recesses 24 and second recesses 24′ for this purpose. Furthermore, the connecting element has locking devices 26, which are formed as locking pins. The connecting element 18 can be locked in the first position by inserting the locking pin into the recesses 24′. To change the position of the connecting element 18, the locking pins of the locking device 26 can be pulled out of the recesses 24′, in particular against a spring load, then the position of the connecting element 18 relative to the housing 12 can be changed and the locking pins can be inserted into the recesses 24 to lock the connecting element in the second position. Two locking pins are shown in the figures as a locking device. However, the number of locking pins is not limited thereto. Thus, only one locking pin or more than two locking pins can be provided as locking device 26.

Even if only two positions are shown in the figures, further positions can be provided by adding further recesses in the example shown. Even if the example in the figures shows the locking device as locking pins, other locking devices, such as a frictional connection, a screw connection or the like, can be used to lock the connecting element 18 in the respective positions.

By adjusting the position of the connecting element 18 rather than the end stop of the piston 14, the overall length H₁ of the drive unit 10 can always be brought into the first position, for example for transportation or handling. As a result, the drive unit has an overall length H₁ that is smaller than an overall length H₂ in the second position of the connecting element 18.

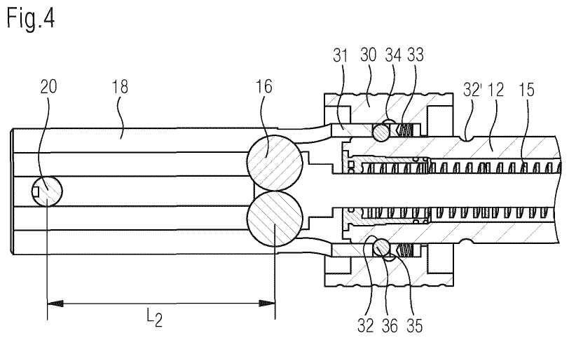

In the following, reference is made to the embodiment shown in FIGS. 4-7. The same or identical components are marked with the same reference numerals.

In the embodiment of FIGS. 4-7, the locking device comprises latching balls 36. Furthermore, a first recess 32′ for locking the connecting element 18 in a first position and a second recess 32 for locking the connecting element 18 in a second position are formed in the housing 12, as shown in FIG. 4. The first recess 32′ and/or the second recess 32 is configured in particular as an annular groove. Due to the configuration of the recesses 32, 32′ as an annular groove, it is possible to freely rotate the connecting element 18 relative to the housing 12 without having to release the locking between the connecting element 18 and the housing 12.

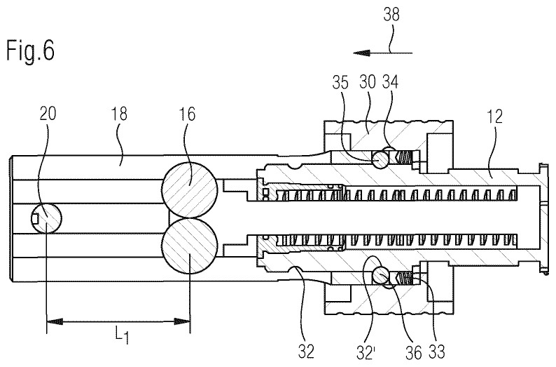

The latching balls 36 are arranged in openings 35 of the sleeve 31 of the connecting element 18. Here, the latching balls 36 have a radius that is thicker than the wall thickness D₃₁ of the sleeve. This means that a part of the latching balls 36 always protrudes beyond the sleeve. In a locking position, shown in FIG. 4 and FIG. 6, the latching ball 36 projects into one of the respective recesses 32, 32′ and locks the connecting element 18 relative to the housing 12. In FIG. 4, the connecting element 18 is shown in a second position, so that the distance L₂ between the stop position of the piston 14 and the receptacle 20 is greater than the distance L₁ shown in FIG. 6 between the stop position of the piston 14 and the receptacle 20 in the first position. For this purpose, the latching ball 36 is locked in the first recess 32′ in the first position.

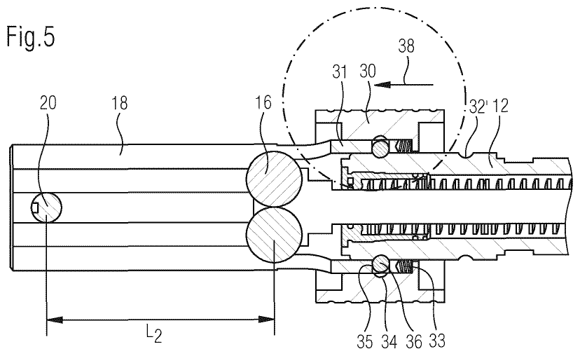

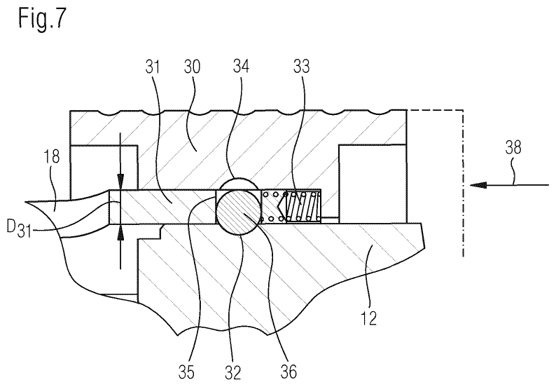

Furthermore, an operating element 30 is provided, which is displaceable in accordance with the arrow 38 and is pretensioned into a locking position by one or more springs 33. In the locking position, shown in FIGS. 4 and 6, the operating element 30 is arranged due to the spring tension of the springs 33 such that depressions 34 in the operating element are not arranged above the openings 35 in the sleeve 31. Latching balls 36 can therefore not be displaced radially outwards into the depressions 34. Only when the operating element 30 is displaced in the axial direction according to the arrow 38, as shown in FIGS. 5 and 7, the depressions 34 are arranged directly radially next to the openings 35, so that the latching balls 36 can be displaced radially outwards from the recesses 32 or 32′ into the depressions 34 of the operating element. Here, the depressions 34 of the operating element 30 can also be configured as an annular groove in order to enable the operating element 30 to be rotated relative to the connecting element 18. Alternatively, the operating element 30 is not rotatable relative to the connecting element 18, so that the relative position in the direction of rotation of the operating element 30 to the connecting element is fixed. As a result, the depressions 34 in the operating element can be configured as spherical recesses, wherein the number of these spherical recesses corresponds to the number of latching balls 36. Thus, the locking of the connecting element 18 relative to the housing 12 can be released and the connecting element 18 can be moved from the first position to the second position or vice versa. If the operating element is then released again by the user, the spring tension of the spring 33 causes the operating element to move back into its locking position as soon as the latching ball 36 is displaceable radially inwards into one of the recesses 32, 32′. An inner surface of the operating element 30 is then again arranged flat and directly above the opening 35 of the sleeve 31, so that the connecting element 18 is again locked relative to the housing 12.

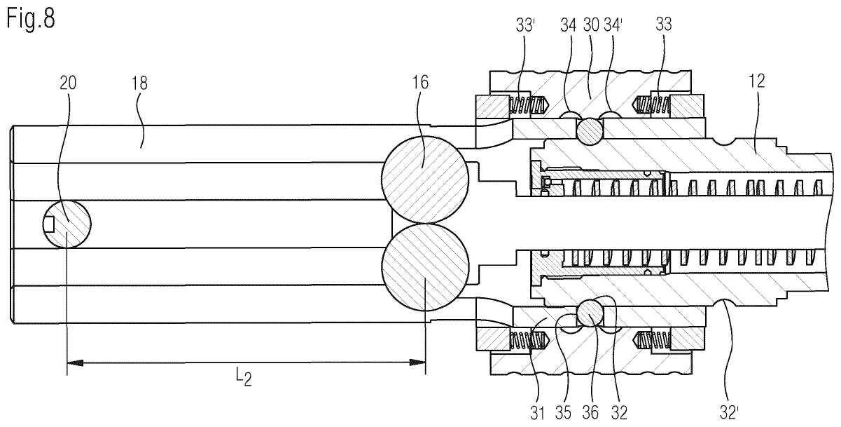

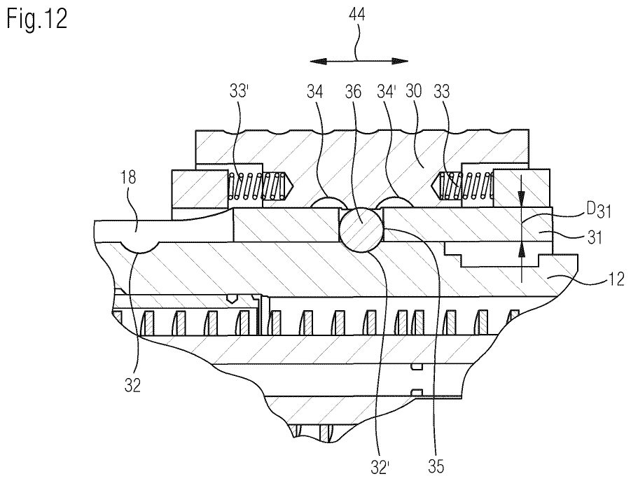

In the following, reference is made to the embodiment shown in FIGS. 8-12. The same or identical components are marked with the same reference numerals.

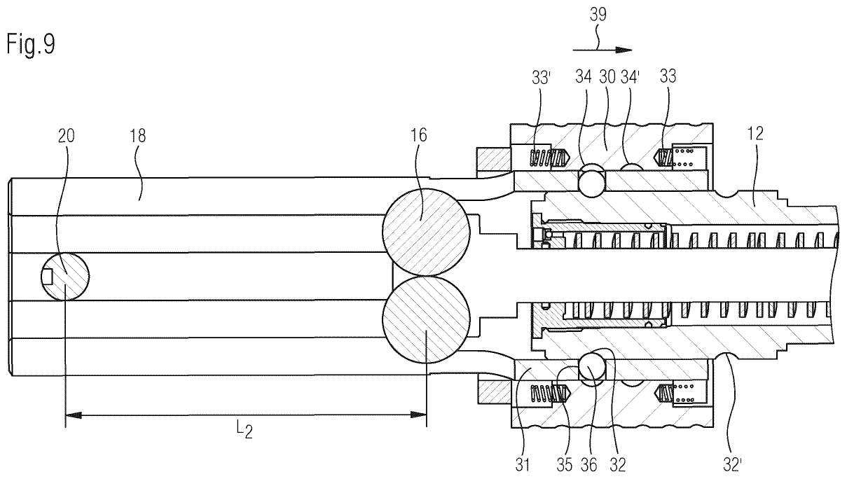

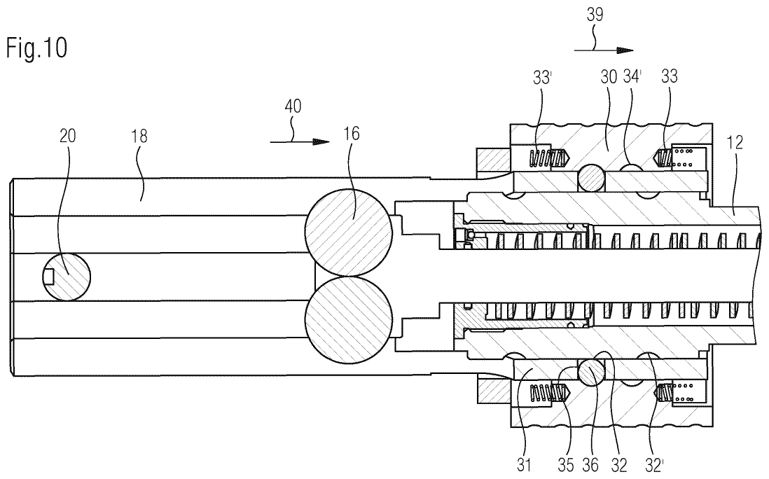

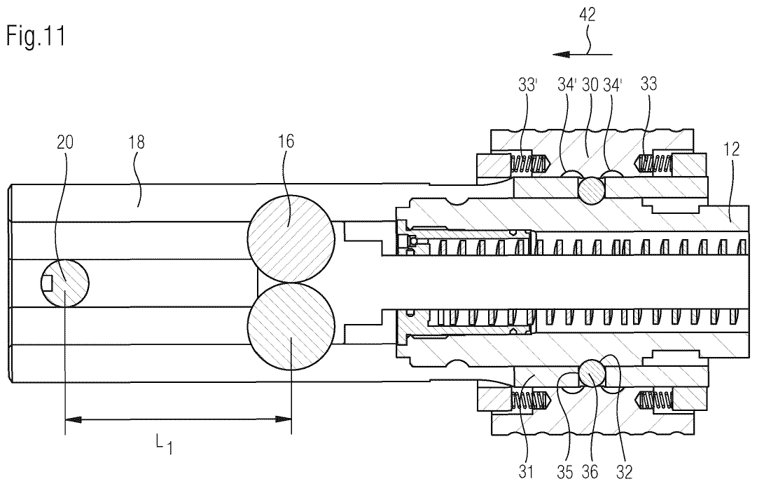

In a further embodiment, shown in FIGS. 8-12 , the operating element 30 has two depressions 34, 34′. Thus, if the connecting element 18 is moved from the second position, shown in FIG. 9, to the first position, shown in FIG. 11, the operating element 30 is displaced axially in the direction of the drive in accordance with the arrow 39 against the spring force of the first spring 33. The latching ball is then radially displaceable in the first depression 34 of the operating element 30. As soon as the latching ball 36 is arranged in the opening 35 of the sleeve 31 and in the depression 34, a simultaneous movement of the operating element 30 and the connecting element 18 from the first position to the second position takes place. This transition is shown in FIG. 10. An axial movement along the arrow 14 of the connecting element 18 is thus caused by a corresponding axial movement of the operating element 30 along the arrow 39. When reaching the first position, shown in FIG. 11, the operating element 30 is released and moved back into the closed position due to the spring force of the first spring 33.

If the connecting element 18 is displaced from the first position, shown in FIG. 11, to the second position, the operating element 30 is displaced against the spring force of the second spring 33′ in the direction of the arrow 42 (also in FIG. 11). At the same time as the operating element 30 is displaced, the connecting element 18 is also displaced as soon as the latching ball 36 is simultaneously arranged in the opening 35 of the sleeve 31 and the second recess 34′ of the operating element 30. This means that the drive unit can be operated with one hand to transfer it from the first position to the second position or vice versa.

1. A drive unit for a pressing device comprising
a housing,
a drive arranged in the housing,
a connecting element which is connected to the housing and has a receptacle for connection to a pressing tool,
a piston which can be moved by the drive from a stop position to a pressing position in order to transmit the force from the drive to the pressing tool, and
wherein the connecting element is lockable in at least a first position and a second position, wherein a distance between the stop position of the piston and the receptacle is different in the first position and in the second position.

2. The drive unit according to claim 1, wherein the distance between the first position and the second position is at least 20 mm, and preferably at least 40 mm.

3. The drive unit according to claim 1, the connecting element comprises a first locking device and/or a second locking device for locking the connecting element in the first position or the second position.

4. The drive unit according to claim 3, wherein the first locking device and the second locking device are of the same or different design.

5. The drive unit according to claim 3, wherein the first locking device and/or the second locking device is in particular a spring-loaded latching element.

6. The drive unit according to claim 5, wherein the latching element is one or more latching balls, wherein the connecting element has a corresponding number of openings for receiving the latching balls, wherein the housing has recesses, wherein the one or more latching balls are arranged simultaneously in the respective opening and the recess for locking in the first position or the second position.

7. The drive unit according to claim 6, wherein an operating element is provided which covers the opening of the connecting element, wherein the operating element is displaceable and comprises one or more depressions, wherein, when the connecting element is released, the operating element is displaced such that one of the depressions corresponds with one of the openings and the latching ball is arranged simultaneously in the opening and the depression and is no longer in engagement with the recess of the housing.

8. The drive unit according to claim 3, wherein the first locking device and/or the second locking device is a frictional connection, in particular a clamping cone.

9. The drive unit according to claim 1, characterized by more than two positions and in particular a continuous adjustment of the connecting element.

10. The drive unit according to claim 1, wherein the connecting element has a thread, wherein the position of the connecting element can be changed by the thread.

11. The drive unit according to claim 1, wherein the stop position of the piston cannot be changed.

12. A pressing device comprising a drive unit according to claim 1, and a pressing tool, wherein the pressing tool is connected to the receptacle of the connecting element.
